(19) United States
(12) Patent Application Publication
(10) Pub. No.: US 2012/0026320 A1
(43) Pub. Date: Feb. 2, 2012

(54) AIRCRAFT TRAFFIC LOGGING AND ACQUISITION SYSTEM

(76) Inventors: Samuel S. Bryceland, Toronto (CA); Lawrence A. Condatore, JR., Clermont, FL (US); David S. Jones, Marietta, GA (US); Michael D. Pitts, Watkinsville, GA (US); Richard T. Reper, Clermont, FL (US); James C. Waldrop, Roswell, GA (US); Cecelia Kuffman, Roswell, GA (US)

(21) Appl. No.: 13/193,536

(22) Filed: Jul. 28, 2011

Related U.S. Application Data
(60) Provisional application No. 61/368,336, filed on Jul. 28, 2010.

(51) Int. Cl. H04N 7/18

(52) U.S. Cl. 348/135; 348/E07.085

(57) ABSTRACT

A portable aircraft identification system including a platform having at least one pair of wheels and a securable ball hitch assembly, a mast having one end fixed to the platform and being erectable to extend vertically from the platform, a camera and lens system mounted adjacent an upper end of the mast with the camera being positioned so as to aim generally horizontally from the mast, a local area network card connected to the camera and adapted for receiving images from the camera and for transmitting the received images to a remote location, a battery compartment mounted on the platform and containing sufficient batteries to power the camera and network card, a solar charging system mounted on the platform and connected for supplying recharge power to the batteries, and a wind turbine charging system mounted on the platform and connected for supplying recharge power to the batteries.

### CROSS-REFERENCE TO RELATED APPLICATIONS

This application claims the benefit of U.S. Provisional Application No. 61/368,336 filed Jul. 28, 2010, and incorporated herein by reference in its entirety.

### BACKGROUND OF THE INVENTION

The present invention relates to a system for monitoring and reporting on airport traffic, and more specifically to video observation and detection systems that visually capture aircraft identification indicia for identifying aircraft activity in airports.

Airport revenue is generally a function of aircraft activity. Those airports that are arrival and departure points for commercial aircraft can usually rely on transponder data to keep track of traffic for billing purposes. Those airports that are used by private aircraft or other small aircraft that are not required to have transponders, or transponders which relay aircraft identification information, have to rely on manual tracking of traffic and on self-reporting by the aircraft operators. As a result, such latter airports lose considerable revenue by failing to accurately track usage by such non-commercial or small aircraft.

Though prior art systems have been suggested for automatically detecting a movement of at least one aircraft within the area, regardless of a time of day when the movement occurs where at least one image of the aircraft is formed when the movement is detected so that automatic identification of a tail number of the one aircraft based on alphanumeric data in the image is possible wherein the tail number and data characterizing the aircraft is automatically stored in a database, such prior art does not provide for a system being mobile where reconfiguring camera settings after moving the system is capable of being handled remotely from the system and rather quickly when compared to prior art stationary systems. Thus, if a need arises to move a stationary system, a work crew is required to deconstruct the system from its current position and move it to another location. To minimize having to move stationary systems, airport operators decide to locate stationary systems at remote locations from a runway, thus requiring the need for more expensive imaging systems.

Further prior art stationary systems usually require power lines to be entrenched within the ground, running from some power source to the stationary system. If the stationary system is moved, then the power lines also have to be moved. Some prior art systems are known to also provide a photovoltaically charged battery to provide power to the stationary system. However, depending on weather conditions, the rechargeable battery is not sufficiently charged to allow for monitoring activity at the airport.

Another drawback with prior art systems is that they were positioned low to the ground where they were designed to look up to a tail number. Such systems are known to miss capturing tail numbers because aircraft wings would block the image device, or camera, from capturing the tail number.

In view of such limitations, airport operators would benefit from a system which is portable so that it can be located at various locations proximate a runway with an imagining system that looks down onto the aircraft when capturing a tail number and further where sustainable power is self-contained with the system where the sustainable power is recharged from more than one rechargeable system or device.

### BRIEF DESCRIPTION OF THE INVENTION

Exemplary embodiments of the present invention provide for an aircraft traffic logging and acquisition system. The system comprises a platform having at least one pair of wheels and an extending support with a securable ball hitch assembly for towing the platform and preventing unauthorized use of the ball hitch assembly. A mast having one end fixed to the platform and being erectable to extend vertically from the platform is also provided. Further provided is a camera and lens system mounted adjacent an upper end of the mast so as to be positioned above surrounding terrain when the mast is in an extended position, the camera being positioned so as to aim generally horizontally from the mast. A local area network card is provided which is connected to the camera and adapted for receiving images from the camera and for transmitting the received images to a remote location. A battery compartment is provided which is mounted on the platform and containing sufficient batteries to supply power to the camera and network card. The system further comprises a solar charging system mounted on the platform and connected for supplying recharge power to the batteries, and a wind turbine charging system mounted on the platform and connected for supplying recharge power to the batteries.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not, therefore, to be considered limiting of its scope, the invention will be described and explained with additional specificity and detail through the use of the accompanying drawings in which:

FIG. 1 discloses an exemplary embodiment of the inventive mobile platform with camera;

FIG. 2 discloses an exemplary embodiment an environmentally sealed box that houses rechargeable batteries and electrical controls;

FIG. 3 discloses an exemplary embodiment of an enlarged view of a camera with a lens system;

FIG. 4 is an example of an image obtained using an exemplary embodiment of the system of the present invention with links for remotely adjusting the camera and lens system;

FIG. 5 discloses another exemplary embodiment of controls once a particular link is selected; and

FIG. 6 discloses other exemplary embodiment of controls once a particular link is selected.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. As disclosed below, multiple versions of a same element may be disclosed. Likewise, with respect to other elements, a singular version is disclosed. Neither multiple versions disclosed nor a singular version disclosed shall be considered limiting. Specifically, although multiple versions are disclosed, a singular version may be utilized. Likewise, where a singular version is disclosed, multiple versions may be utilized.

Though exemplary embodiments of the invention are disclosed with respect to aircraft traffic logging and acquisition, exemplary embodiments of the invention are also applicable for other uses, specifically at a municipal airport. For example, exemplary embodiment of the invention may be used notify an entity, such as, but not limited to, a security guard and/or law enforcement, when a runway is being used during a time when the airport is closed. Further it can be used to detect unauthorized individuals trespassing on the airport grounds. For example, should an individual attempt to enter by climbing over a fence, an exemplary embodiment of the invention can record this activity and send a message to the entity mentioned above, provided that the activity is occurring within the field of view of the camera and lens system disclosed herein.

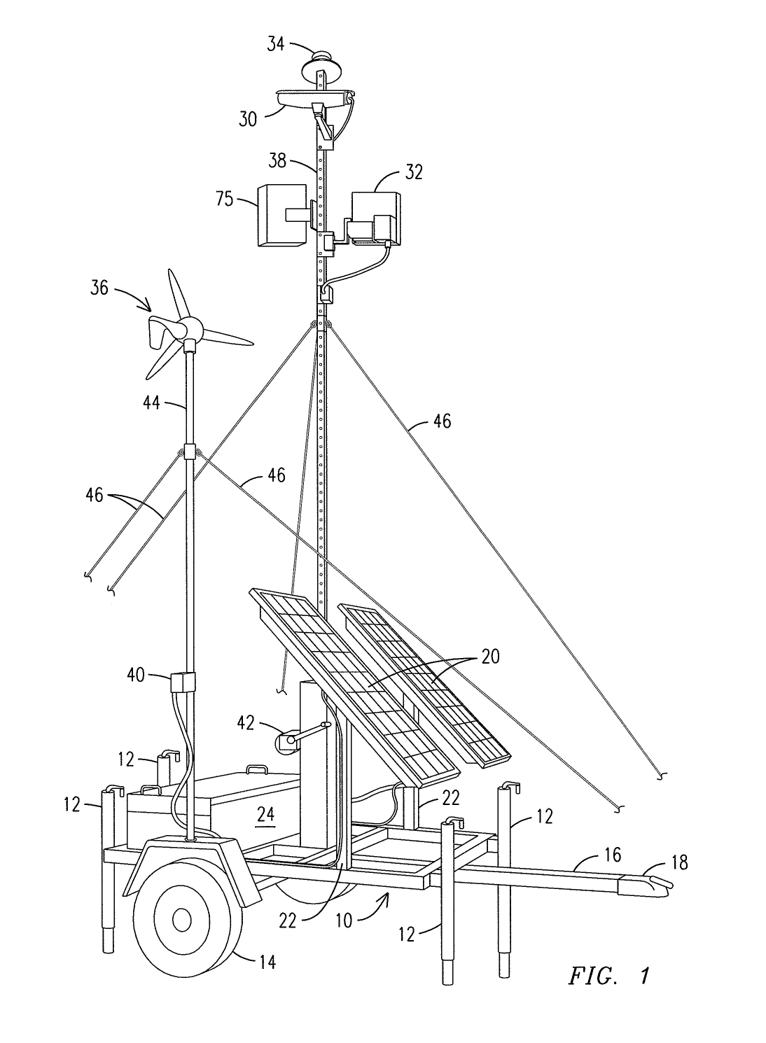

Reference is now made to FIG. 1 in which is illustrated one form of the inventive mobile platform with camera. The platform 10 comprises a 2-wheeled trailer having a plurality of jacks 12 allowing the platform to be raised off the wheels 14 and leveled on most terrains. The trailer includes a conventional lift arm 16 with a securable ball hitch assembly 18 to allow transport by motor vehicle, namely by towing the platform behind the vehicle. Once the platform is put into position, and to prevent unauthorized moveability, the ball hitch 18 is configured to be adjustable to prevent theft of the system since another ball will be unable to fit within the hitch. For example, the assembly 18 can be retracted so that a ball can not fit within the receptor for receiving a ball. In another example, the assembly can be rotated so that the receptor is not in a downward position to accept a ball.

A pair of solar panels 20 is mounted on standards 22 attached to the platform. The angle of the panels 20 may be adjusted to maximize solar power. Such panels and mounting hardware are commercially available from various sources such as, for example, Northern Tool and Equipment Company of Burnsville, Minn. Adjusting the panels may be performed manually and/or electronically where commands may be provided from a remote location. A controller, not shown, may be

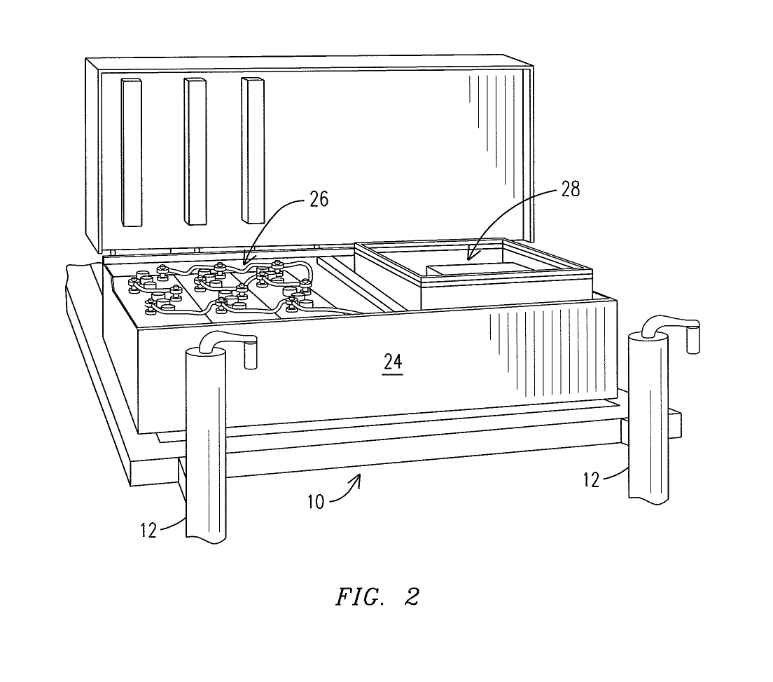

Mounted to the platform 10 is an environmentally sealed box, or compartment, 24 that houses the rechargeable batteries 26 (see FIG. 2) and the electrical controls 28, or controllers, for the various items on the platform such as the camera 30, the network box and card 32, adjusting the solar panels 20, and the required warning light 34. The controls 28 may also be the battery charging connections from the solar panel and wind turbine 36. Though a first controller and a second controller are disclosed herein, all control or controllers may be considered controls, or controllers, 28.

The telescoping camera support pole or mast 38 extends from a central support 40 that includes lifting mechanism, such as but not limited to a conventional manual indicated generally at 42, for extending and retracting the mast 38. Though manual lifting is illustrated, motorized lifting is also possible. The mast may be raised to an acceptable height for a camera 30 to be elevated above a terrain. The mast 38 is also attached to the platform in such a manner that it can be folded to lay onto the platform for transport to another location. The turbine 36 is mounted atop another pole 44 attached to the platform 10. The turbine 36 is mounted with a pivoting joint so that the turbine 36 freely rotates, based on the configuration of the turbine, to ensure that the turbine always turns into the wind. Each of the poles 38 and 44 is supported by guy wires 46 that are attached to ground stakes.

The camera 30 comprises a commercially available digital camera such as a Nikon or Canon that is sized and shaped to fit to an extended lens system. The camera 30 produces a sequence of still images using a high density CCD receptor and the images are transferred by the camera electronics to an internal memory before being transferred to the network card 32. The network card includes a commercially available LAN card with WiFi, WiMax or BlueTooth or other network capability that allows remote access for direct viewing of images from the camera. The card 32 is network addressable to allow real-time viewing of the images being generated by the camera 30. In addition, the card 32 automatically transmits the images to a remote storage location (not shown) where the images can be stored on a hard drive for later access using its integrated wide area connection protocol.

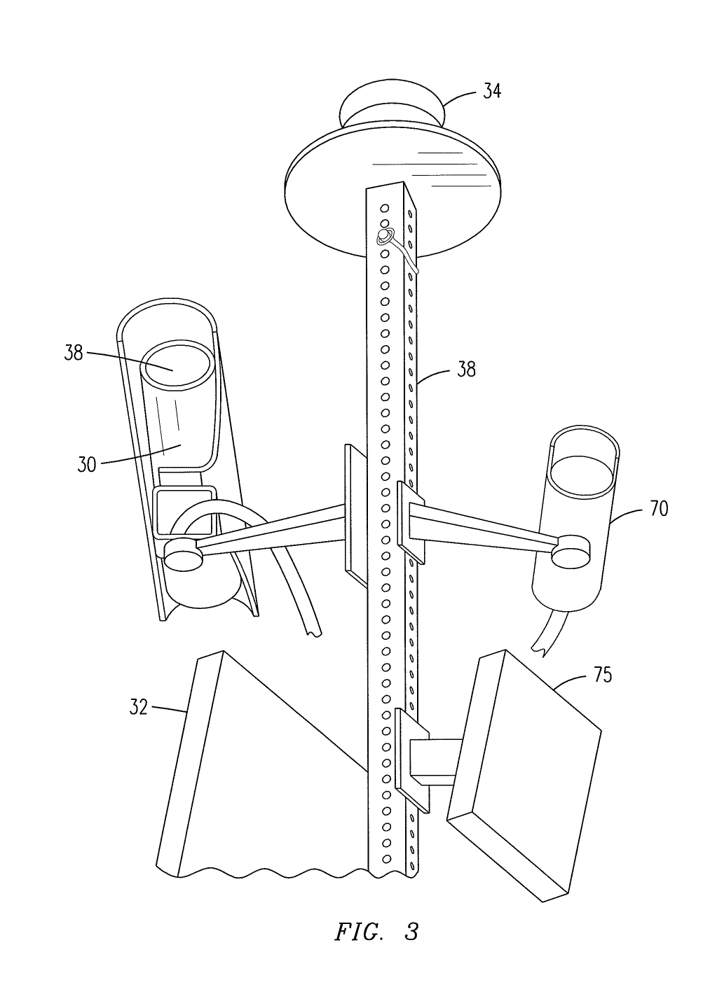

The camera 30 also has a lens system 48. An enlarged view of the camera 30 with a lens system 48 is shown in FIG. 3. This latter figure also shows the warning light 34 atop the pole 38. Also shown is a detection system 70, such as but not limited to a passive infrared receiver, to detect when an object is within a field of view of the camera. Additional discussion about the detection system 70 is provided below. Also disclosed is a light flash, or illuminator, 75. The illuminator 75 is used to further enhance image capture. The camera may be synchronized with the light flash, or illuminator. The light flash 75 may be in a frequency spectrum that is not disturbing to an aircraft operator, such as in the infrared spectrum.

For completeness of description and implementation of the present invention, the technical aspects and disclosure of U.S. Publication No. 2002/0082769, which discloses a permanently mounted aircraft identification system and method, are hereby incorporated by reference.

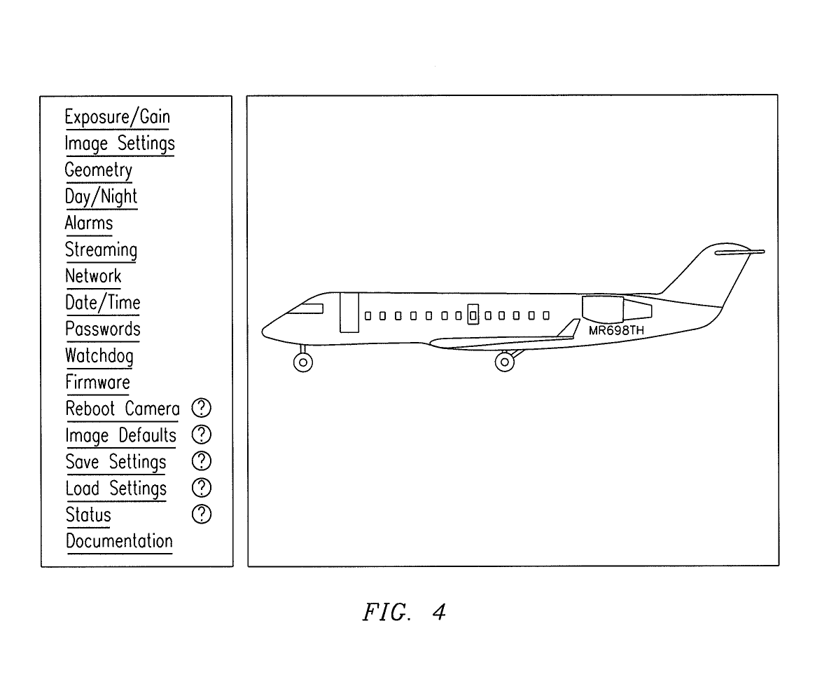

FIG. 4 is an example of one image obtained using the system of the present invention. This figure shows a commercial aircraft with a tail located on the rear fuselage below the engines. It is noted that the tail number is clearly readable in this image. Exemplary embodiments of the present invention utilizes raw image data that allows for processing dark and low contrast images to extract tail numbers. Also illustrated in FIG. 4 are links to change various operational aspects of the system. Though illustrated together in FIG. 4, when the images are captured, the links do not have to be included with the image capture, and are usually not included. An individual having access to adjust the system may have these links 60 visible in addition to the actual image viewable from the camera and lens when the links 60 are accessed.

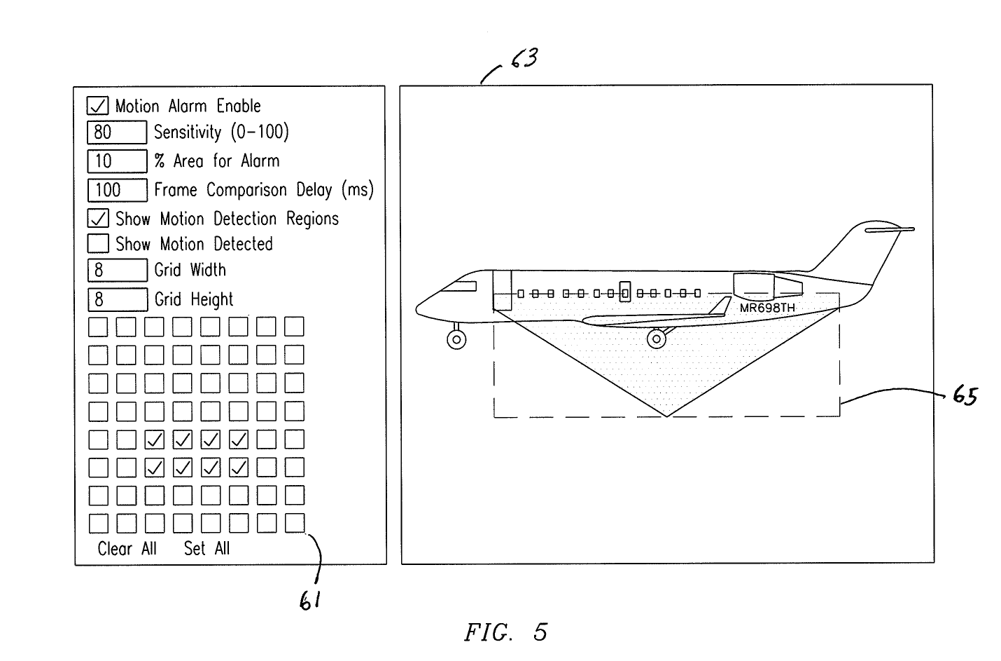

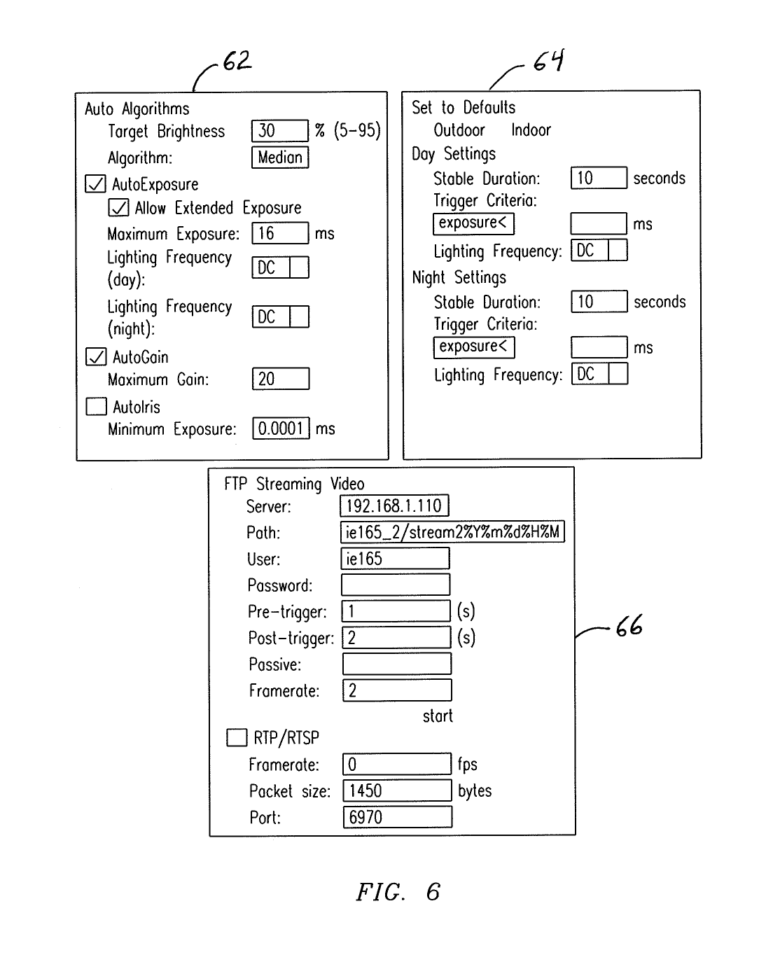

FIG. 5 depicts another exemplary embodiment of data controls, more specifically setting that a user may set for operation of the system, once a particular link is selected, specifically the Alarm link. As illustrated, a grid 61 is provided where the user can identify where the field of view should be focused. A marking 65 is provided in a display 63 of what the camera is viewing that corresponds with boxes selected in the grid 61. FIG. 6 depicts other exemplary embodiment of controls once the particular link is selected. For example, the Exposure Gain link provides for an auto algorithm control page 62. The Day/Night link discloses a control page 64 to set defaults for the system. The streaming link discloses a control page 66 to input such information, such as, but not limited to, a server address, Internet path, and trigger timing. The user can access these controls from the remote location. The remote location can include a portable device, such as a tablet computer and/or a cell phone. The conto

As explained above, an exemplary embodiment of the present invention also uses a camera and special optics to capture an image of an aircraft on a runway, memory for storing the captured image and a network card for transmitting the captured image to a remote location and for allowing real time access to images being captured. In a preferred embodiment, the camera and associated electronics are located on a portable trailer that can be located in any desired location for best viewing of activity on a runway of an airport. The portable trailer is also self-powered by on-board rechargeable batteries. The batteries are charged by a solar array and a wind turbine attached to the trailer. Both the solar array and wind turbine can provide a charge to the batteries regardless of whether the other rechargeable source is charging the batteries, or a first controller 28 may be included allowing only one to charge the batteries. For example, should the first controller detect that the solar array is not providing a sufficient charge, for example due to inclement weather, the controller 28 allow for only the wind turbine to provide the charge to the batteries. A typical wind turbine is available from Southwest Windpower, Inc. under their tradename AIR-X and includes the turbine as well as the alternator, rectifier and charging controller.

Images captured by the present invention are transmitted to a remote location such as one of the local environmentally controlled buildings on airport property. From that location, the images may be accessed via an internet connection for processing at another location or locally processed at the airport location. The images are captured in a raw format, preferably in non-color, so as to allow maximum processing of the image. This feature permits identification of aircraft tail numbers under minimum visibility conditions. For example, tail numbers having very low contrast in low light conditions can still be identified by adjusting the image characteristics such as contrast, color and gamma.

In an exemplary embodiment, a high quality lens system is used to maximize light collection, focus and clarity. For example, the lens system may be constructed using optical elements from celestial telescopes that are remounted in carbon fiber tubes to provide high magnification without distortion to enable reading of numbers only four inches high at distances greater than one-half mile.

Tail numbers identified using the present system can be inputted into a database created from FAA registrations, aircraft owner filings, aircraft financing filings including liens on aircraft and tax rolls. The system will then identify the aircraft owner/operator to enable the airport authority to bill the owner/operator for use of the airport. In addition, for local airports that may receive tax funds for operation, the system allows identification of local owners so that they may be excluded from payment for airport use supported by their taxes. The system can also identify aircraft based at the airport that may be excluded from payment of additional landing fees. In a preferred embodiment, invoicing for airport landing fees may be automatically generated from the identification system.

The present system may include a detection system 70, such as a sensor, to enable image capture only when an aircraft is present or may be set to provide image capture at spaced time intervals such as, for example, every three seconds. An exemplary example for the detection system 70 is a passive infrared receiver, as is illustrated in FIG. 3. While this latter technique generates more images, it eliminates the requirement for additional equipment to detect aircraft presence. The image capture software can be adapted to discard any image that does not include an aircraft so as to minimize the size of memory required for image storage. This technique also can be used to provide real time imaging of actual weather conditions at the airport by detecting fog, rain and ice that may affect runway accessibility. Storage of all images at the remote location also may be used for airport security and, therefore, be desirable over discarding of non-aircraft containing images. A second controller 28 may be provided which is operably connected, or coupled, to the second controller 28 and configured to generate a detection signal and communicate the detection signal to the second controller 28. The second controller 28 is configured to cause the camera and lens system to capture video of the field of view when a detection signal has been received from the sensor 70 by the second controller 28. As explained above, though the terms “first controller” and “second controller” are disclosed, either a plurality of controllers or a single controller may be used. Therefore, those skilled in the art will readily recognize that identifying a first controller and a second controller is only done to distinguish the specific functions, but that a single controller may be used, as further explained below.

Exemplary embodiment of the present invention takes advantage of the fact that the visible light energy coming from our Sun is only about 15% of its total output. The other 85% is of a wave length humans cannot see. This same phenomenon of light energy holds true for any light source whose origin is thermal or black-body radiation including incandescent. At night, when the Sun is below the horizon, much of the available light energy is still emanating from black-body radiation in the form of city lights (tungsten generated), reflected light from the moon and star light.

The inventive system does three things to take full advantage of this available light energy. A first thing is to tune every optical component in the system to accommodate the non-visible wavelengths. This includes the combining of pixels to affect larger sensor components increasing sensitivity and the use of special coating to accommodate the transmission of this wavelength energy through the optics to the sensors. A second thing is to recognize that the preponderance of available light energy is coming from a high angle of incident and the majority of target data is retroreflective in nature. Accordingly, the imaging sensors that are part of the camera and/or lens system are positioned well above the tarmac/runway surface to accommodate and receive into the sensor aperture this retroreflective energy. A third thing is to take advantage of the full spectrum of light when the Sun is above the visible horizon. However, this presents certain challenges since the longer wavelengths of the light spectrum focus at a different point than the shorter wavelengths. Two methods can be used to accommodate the difference in focal point. One is by using long-pass filters to eliminate the shorter waves from the spectrum and, therefore, maintain a constant focal plane. Another is to use unique optics that compensate for the varying wavelength so that they are focused at the same plane.

Exemplary embodiments of the present system provide for the portability of the system and the ability to position the height of the camera or imaging device at a best location to observe the aircraft ID, N number or tail number. While the ID number is commonly referred to as a tail number, there is no specification that requires the number to be placed in a fixed location. As a result, aircraft ID numbers may be located anywhere on the air frame. In addition, the aircraft wing shape as well as tail configuration can obscure the number. To that end, the ability to elevate the camera platform is critical to the image capture effort. In one embodiment, this elevating function is achieved by mounting the camera on a telescoping pole attached to the system trailer. The pole may be manually adjustable using a conventional crank system or may incorporate a motorized system that may be remotely accessed to adjust the height of the camera. By positioning the trailer/camera platform in the best position for observing aircraft takeoff as well as for receiving the greatest amount available light regardless of its source or direction, system performance can be maximize. The mobile platform also provides the ability to relocate the camera and lens system quickly if an anticipated or unanticipated change in runway access occurs.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated, any use of the terms first, second, etc., does not denote any order or importance, but rather the terms first, second, etc., are used to distinguish one element from another and/or to distinguish different functionality where one element may be able to perform multiple functions.

What is claimed is:

1. A portable aircraft identification system comprising:
a platform having at least one pair of wheels and an extending support with a securable ball hitch assembly for towing the platform and preventing unauthorized use of the ball hitch assembly;
a mast having one end fixed to the platform and being erectable to extend vertically from the platform;
a camera and lens system mounted adjacent an upper end of the mast so as to be positioned above surrounding terrain when the mast is in an extended position, the camera being positioned so as to aim generally horizontally from the mast;
a local area network card connected to the camera and adapted for receiving images from the camera and for transmitting the received images to a remote location;
a battery compartment mounted on the platform and containing sufficient batteries to supply power to the camera and network card;
a solar charging system mounted on the platform and connected for supplying recharge power to the batteries; and
a wind turbine charging system mounted on the platform and connected for supplying recharge power to the batteries.

2. The portable aircraft identification system according to claim 1, further comprising a detection system configured to detect a presence of an object in a field of view of the camera.

3. The portable aircraft identification system according to claim 1, further comprising a warning light attached atop the mast on which the camera is mounted.

4. The portable aircraft identification system according to claim 1, further comprising a remote receiving system for receiving image data from the network card.

5. The portable aircraft identification system according to claim 4, wherein the remote receiving system is further configured for storing the images on a hard drive for review.

6. The portable aircraft identification system according to claim 1, further comprising a first controller for determining whether the solar charging system and/or the wind turbine charging system should supply recharge power to the batteries.

7. The portable aircraft identification system according to claim 1, wherein the turbine is mounted atop the another mast with a pivoting joint to allow the wind turbine to always turn into wind.

8. The portable aircraft identification system according to claim 4, wherein the remote receiving system is an electronic system having a visual display.

9. The portable aircraft identification system according to claim 1, further comprising a second controller wherein the detection system is operably coupled to the second controller and configured to generate a detection signal and communicate the detection signal to the second controller.

10. The portable aircraft identification system according to claim 9, wherein the second controller is configured to cause the camera to capture video of the field of view when a detection signal has been received from the detection system by the second controller.

11. The portable aircraft identification system according to claim 1, wherein the mast is foldable and telescopeable to place the mast in a stored configuration when the system is moved, and to select an acceptable height for the camera and lens system to be elevated.

12. The portable aircraft identification system according to claim 1, wherein the camera and lens system combine of pixels to affect larger sensor components to increase sensitivity.

13. The portable aircraft identification system according to claim 1, wherein the lens system uses a coating to accommodate transmission of wavelength energy through optics to at least one sensor within the camera and lens system.

14. The portable aircraft identification system according to claim 1, wherein the camera and lens system further comprises at least one imagining sensor which is positioned to accommodate retro reflective energy generated as a result of a high angle of incident and the target data from an object within a field of view of the camera and lens system.

15. The portable aircraft identification system according to claim 1, wherein the camera and lens system comprises at least one long-pass filter.

16. The portable aircraft identification system according to claim 1, wherein the camera and lens system comprises optics that compensate for varying wavelength so that the optics are focused at a same plane.

17. The portable aircraft identification system according to claim 1, wherein the securable ball hitch assembly is configured to adjust to prevent a ball from fitting within a ball receptor on the ball hitch assembly.

18. The portable aircraft identification system according to claim 1, wherein the local area network card is network addressable to allow real-time viewing of the images being generated by the camera.

19. The portable aircraft identification system according to claim 1, wherein the wind turbine is mounted atop another mast extending vertically from the platform.

20. The portable aircraft identification system according to claim 1, further comprises an illuminator to illuminate a field of view of the camera when an object is detected.
